(19) United States
(12) Patent Application Publication
(10) Pub. No.: US 2022/0174358 A1
(43) Pub. Date: Jun. 2, 2022

(54) CONTENT MODERATION FOR EXTENDED REALITY MEDIA

(71) Applicants: AT&T Intellectual Property I, L.P., Atlanta, GA (US); AT&T Mobility II LLC, Atlanta, GA (US)

(72) Inventors: Eric Zavesky, Austin, TX (US); Terrel Lecesne, Round Rock, TX (US); James Pratt, Round Rock, TX (US); Jason Decuir, Cedar Park, TX (US)

(21) Appl. No.: 17/105,728

(22) Filed: Nov. 27, 2020

(51) Int. Cl. H04N 21/454; G06K 9/00; H04N 21/442; H04N 21/81; H04N 21/44; H04N 21/439; H04N 21/475

(52) U.S. Cl. CPC H04N 21/454; G06K 9/00624; H04N 21/442; G06K 2209/25; H04N 21/44008; H04N 21/4394; H04N 21/4755; H04N 21/816

(57) ABSTRACT

An example method includes detecting a request from a first user endpoint device to play back an extended reality media, detecting a moderation rule associated with a user of the first user endpoint device, presenting the extended reality media on the first user endpoint device, while monitoring for content within the extended reality media that triggers the moderation rule, determining, in response to detecting content in the extended reality media that triggers the moderation rule, a modification to be made to the extended reality media that would prevent the extended reality media from triggering the moderation rule, and presenting the modification on the user endpoint device, simultaneously with the extended reality media, to render a modified extended reality media.

The present disclosure relates generally to media distribution, and relates more particularly to devices, non-transitory computer-readable media, and methods for providing content moderation for extended reality media.

### BACKGROUND

Consumers (e.g., users of media content, hereinafter also referred to as simply “users”) are being presented with an ever increasing number of services via which media content can be accessed and enjoyed. For instance, streaming video and audio services, video on demand services, social media, and the like are offering more forms of content (e.g., short-form, always-on, raw sensor feed, etc.) and a greater number of distribution channels (e.g., mobile channels, social media channels, streaming channels, just-in-time on-demand channels, etc.) than have ever been available in the past. As the number of choices available to users increases and diversifies, service providers seeking to retain their customer bases are looking for ways to increase the engagement of their customers with their content.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for providing content moderation for extended reality media may operate;

FIG. 2 illustrates a flowchart of an example method for providing content moderation for extended reality media, in accordance with the present disclosure; and

FIG. 3 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for providing content moderation for extended reality media. In one example, a method performed by a processing system includes detecting a request from a first user endpoint device to play back an extended reality media, detecting a moderation rule associated with a user of the first user endpoint device, presenting the extended reality media on the first user endpoint device, while monitoring for content within the extended reality media that triggers the moderation rule, determining, in response to detecting content in the extended reality media that triggers the moderation rule, a modification to be made to the extended reality media that would prevent the extended reality media from triggering the moderation rule, and presenting the modification on the user endpoint device, simultaneously with the extended reality media, to render a modified extended reality media.

In another example, a non-transitory computer-readable medium may store instructions which, when executed by a processing system in a communications network, cause the processing system to perform operations. The operations may include detecting a request from a first user endpoint device to play back an extended reality media, detecting a moderation rule associated with a user of the first user endpoint device, presenting the extended reality media on the first user endpoint device, while monitoring for content within the extended reality media that triggers the moderation rule, determining, in response to detecting content in the extended reality media that triggers the moderation rule, a modification to be made to the extended reality media that would prevent the extended reality media from triggering the moderation rule, and presenting the modification on the user endpoint device, simultaneously with the extended reality media, to render a modified extended reality media.

In another example, a device may include a processing system including at least one processor and non-transitory computer-readable medium storing instructions which, when executed by the processing system when deployed in a communications network, cause the processing system to perform operations. The operations may include detecting a request from a first user endpoint device to play back an extended reality media, detecting a moderation rule associated with a user of the first user endpoint device, presenting the extended reality media on the first user endpoint device, while monitoring for content within the extended reality media that triggers the moderation rule, determining, in response to detecting content in the extended reality media that triggers the moderation rule, a modification to be made to the extended reality media that would prevent the extended reality media from triggering the moderation rule, and presenting the modification on the user endpoint device, simultaneously with the extended reality media, to render a modified extended reality media.

As discussed above, as the number of services via which users may access media content increases and diversifies, service providers seeking to retain their customer bases are looking for ways to increase the engagement of their customers with their content. Some approaches attempt to maximize a user's engagement with content by making the content immersive. For instance, extended reality (XR), which includes virtual reality (VR), augmented reality (AR), and mixed reality (MR) media, has recently emerged as a means to not just increase user engagement with new media, but also to help users engage in new ways with existing media. For instance, newly-rendered computer-generated overlays, when presented in a synchronized manner with an older, more traditional (e.g., non-immersive film), could produce an immersive experience.

One problem that is often experienced when trying to adapt existing, non-immersive media for immersive experiences is how to address content that may be considered outdated. For instance, thirty or forty years ago, it would have been seen as perfectly acceptable to depict a character smoking; even characters in children's cartoons were occasionally seen with cigarettes. In the present, however, characters in television and film are very rarely shown smoking. Similarly, there is a growing sensitivity toward imagery in children's media that could be seen as promoting candy, fast food, and other unhealthy products. Some content creators choose to leave potentially outdated (or otherwise potentially objectionable) content alone, and simply provide a disclaimer at the beginning of the media playback. Other content creators may try to blur or obscure the objectionable elements in the media, but this often ends up looking strange and may even draw more attention to the elements that the content creator is trying to cover up.

Examples of the present disclosure provide a means of moderating content in the generation of XR media. The content to be filtered may be selected by the user for whom the XR media is being rendered; thus, different versions of the XR media may be rendered for different users. For instance, a first user could request that cigarettes or drugs be filtered out of the XR media, while a second user could request that guns be filtered out. In further examples still, rather than the user, it may be the distribution platform for the XR media that imposes the content moderation.

Further examples of the present disclosure could also be applied to enhance advertising opportunities in XR media. For instance, one corporate logo could be filtered out, and another corporate logo could be substituted in its place.

Although examples of the present disclosure are discussed within the context of visual media, it will be appreciated that the examples described herein could apply equally to non-visual media, or to media that does not have a visual component. For instance, examples of the present disclosure could be used to dynamically adapt a podcast, a streaming radio station, an audio book, or the like.

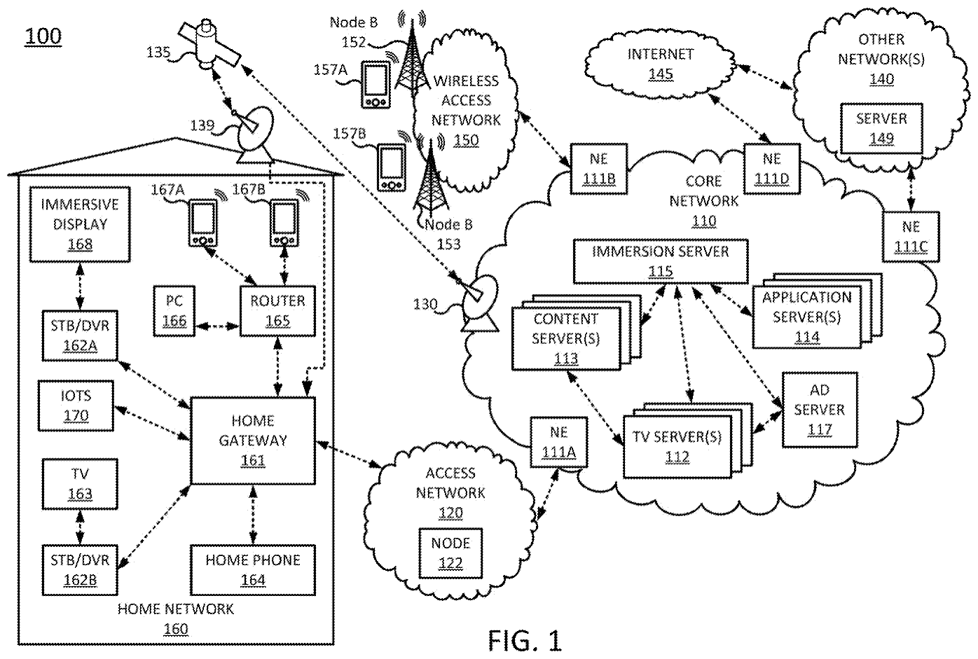

To better understand the present disclosure, FIG. 1 illustrates an example network 100, related to the present disclosure. As shown in FIG. 1, the network 100 connects mobile devices 157A, 157B, 167A and 167B, and home network devices such as home gateway 161, set-top boxes (STBs) 162A, and 162B, television (TV) 163, home phone 164, router 165, personal computer (PC) 166, immersive display 168, and so forth, with one another and with various other devices via a core network 110, a wireless access network 150 (e.g., a cellular network), an access network 120, other networks 140 and/or the Internet 145. In some examples, not all of the mobile devices and home network devices will be utilized in providing content moderation for extended reality media. For instance, in some examples, presentation of an extended reality media may make use of the home network devices (e.g., immersive display 168, STB/DVR 162A, and/or Internet of Things devices (IoTs) 170), and may potentially also make use of any co-located mobile devices (e.g., mobile devices 167A and 167B), but may not make use of any mobile devices that are not co-located with the home network devices (e.g., mobile devices 157A and 157B).

In one example, wireless access network 150 comprises a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 150 may comprise an access network in accordance with any “second generation” (2G), “third generation” (3G), “fourth generation” (4G), Long Term Evolution (LTE) or any other yet to be developed future wireless/cellular network technology including “fifth generation” (5G) and further generations. While the present disclosure is not limited to any particular type of wireless access network, in the illustrative example, wireless access network 150 is shown as a UMTS terrestrial radio access network (UTRAN) subsystem. Thus, elements 152 and 153 may each comprise a Node B or evolved Node B (eNodeB).

In one example, each of mobile devices 157A, 157B, 167A, and 167B may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, a wearable smart device (e.g., a smart watch or fitness tracker), a gaming console, and the like. In one example, any one or more of mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session

Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, Internet 145, wireless access network 150, access network 120, and so forth. As shown in FIG. 1, core network 110 may also include a plurality of television (TV) servers 112, a plurality of content servers 113, a plurality of application servers 114, an advertising server (AS) 117, and an immersion server 115 (e.g., an application server). For ease of illustration, various additional elements of core network 110 are omitted from FIG. 1.

In one example, immersion server 115 may monitor a playback of an immersive experience including XR media, which may be delivered to a device in the home network 160 (e.g., one or more of the mobile devices 157A, 157B, 167A, and 167B, the PC 166, the home phone 164, the TV 163, the immersive display 168, and/or the Internet of Things devices (IoTs) 170) by the TV servers 112, the content servers 113, the application servers 114, the ad server 117, and/or the immersion server 115. For instance, the immersion server 115 may monitor the video, audio, and/or other components of the XR media for the occurrence of content for which a user has requested moderation. The content for which the user has requested moderation may be content that the user wishes to have filtered from the XR media.

In one example, the immersion server 115 may monitor for general types of content (e.g., violence, strong language, etc.). In another example, the immersion server may monitor for more specific content instances (e.g., cigarettes, guns, keywords, etc.). In one example, where the components of the XR media (e.g., audio components, video components, and/or other components) are prerecorded, metadata associated with the components may indicate where content of certain types may occur (for instance, metadata may indicate which frames of the audio component depict a cigarette). In one example, the types of content for which the immersion server monitors the XR media may be defined in one or more moderation rules. A moderation rule may define at least a trigger that invokes the rule (e.g., an occurrence of content for which moderation is requested) and may additionally define how to modify the XR media to moderate the trigger.

In another example, the immersion server 115 may analyze the components of the XR media in order to detect the occurrences of triggers. For instance, image processing techniques including object recognition, facial recognition, and the like could be used to detect specific objects or people who are depicted in the video component of the XR media. For instance, object recognition techniques could be used to detect when a cigarette is visible in the XR media.

Similarly, audio processing techniques including speech recognition, sentiment recognition, and the like could be used to detect specific words that are spoken in the audio component of the XR media (e.g., by characters, in narration or voiceover, in songs, etc.). Recognized words could be compared to a list of keywords, where the list of keywords includes words that should be filtered out of the XR media (e.g., swearing, insults, etc.).

When the immersion server 115 detects a trigger in the XR media, the immersion server 115 may generate a modification to the XR media that results in the XR media not triggering a moderation rule. In one example, the nature of the modification may be predefined by the moderation rule that is triggered. For instance, a moderation rule may specify that instances of cigarettes detected in the video component of the XR media should be replaced with lollipops. A different moderation rule may specify that the cigarettes should simply be removed from the video component (and replaced with nothing). The modification may be prerecorded and provided by the creator of the XR media (or by a third party).

In another example, the immersion server 115 may generate a modification, if no predefined modification is associated with the moderation rule. For instance, the immersion server may generate a digital overlay to remove content from the video component of the XR media or simply replace the detected trigger associated with a potentially offensive item with a default item, e.g., replacing cigarette, cigar, smoking pipe, vaping apparatus with a toothpick, a lollipop and the like. Alternatively, the immersion server may generate an alternate audio track to play in place of a portion of the audio component.

In one example the immersion server 115 may have access to user profiles that store moderation rules for users associated with the user profiles. The user profiles may be retrieved from network storage, e.g., application servers 114, by the immersion server 115. For instance the user profiles may be maintained by a network service (e.g., an Internet service provider, a streaming media service, a gaming subscription, etc.). As discussed above, each moderation rule may specify a trigger (e.g., content to be moderated) as well as a modification to be made to the XR media to moderate the trigger. For instance, a moderation rule may specify that images of cigarettes (the trigger) in the video component of the XR media should be replaced with images of lollipops (the modification). User profiles may be defined by users, and may be defined for specific individual users or for groups or demographics of users (e.g., children younger than 12 years old).

The immersion server 115 may also have access to third party data sources (e.g., server 149 in other network 140), where the third party data sources may comprise content that can be used to generate modifications to moderate XR media.

The immersion server 115 may interact with television servers 112, content servers 113, and/or advertising server 117, to select which video programs (or other content), advertisements, and/or modifications to include in XR media being delivered to a user endpoint device. For instance, the content servers 113 may store scheduled television broadcast content for a number of television channels, video-on-demand programming, local programming content, gaming content, and so forth. The content servers 113 may also store other types of media that are not audio/video in nature, such as audio-only media (e.g., music, audio books, podcasts, or the like) or video-only media (e.g., image slideshows). For example, content providers may upload various contents to the core network to be distributed to various subscribers. Alternatively, or in addition, content providers may stream various contents to the core network for distribution to various subscribers, e.g., for live content, such as news programming, sporting events, and the like. In one example, advertising server 117 stores a number of advertisements that can be selected for presentation to subscribers, e.g., in the home network 160 and at other downstream viewing locations. For example, advertisers may upload various advertising content to the core network 110 to be distributed to various viewers.

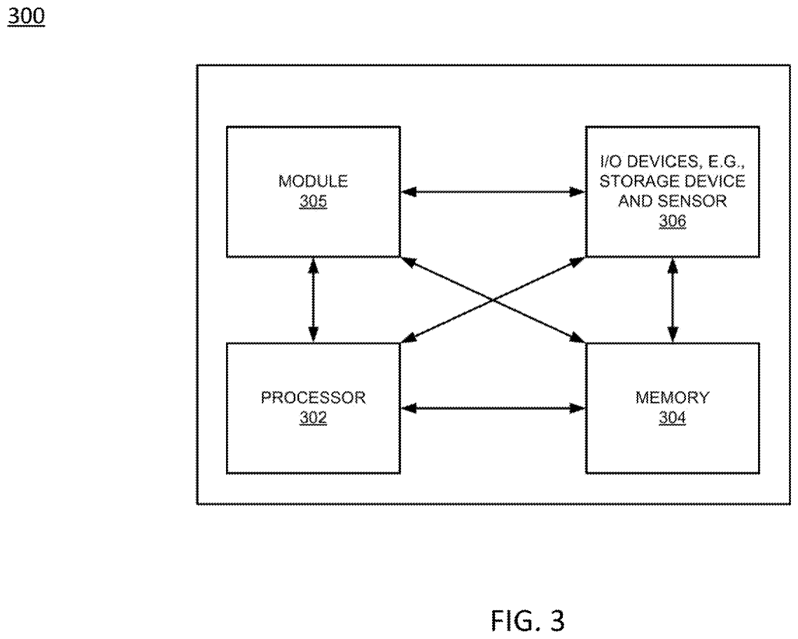

In one example, any or all of the television servers 112, content servers 113, application servers 114, immersion server 115, and advertising server 117 may comprise a computing system, such as computing system 300 depicted in FIG. 3.

In one example, the access network 120 may comprise a Digital Subscriber Line (DSL) network, a broadband cable access network, a Local Area Network (LAN), a cellular or wireless access network, a 3^{rd} party network, and the like. For example, the operator of core network 110 may provide a cable television service, an IPTV service, or any other type of television service to subscribers via access network 120. In this regard, access network 120 may include a node 122, e.g., a mini-fiber node (MFN), a video-ready access device (VRAD) or the like. However, in another example node 122 may be omitted, e.g., for fiber-to-the-premises (FTTP) installations. Access network 120 may also transmit and receive communications between home network 160 and core network 110 relating to voice telephone calls, communications with web servers via the Internet 145 and/or other networks 140, and so forth.

Alternatively, or in addition, the network 100 may provide television services to home network 160 via satellite broadcast. For instance, ground station 130 may receive television content from television servers 112 for uplink transmission to satellite 135. Accordingly, satellite 135 may receive television content from ground station 130 and may broadcast the television content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the core network 110. In another example, satellite 135 may be controlled and/or operated by a different entity and may carry television broadcast signals on behalf of the core network 110.

In one example, home network 160 may include a home gateway 161, which receives data/communications associated with different types of media, e.g., television, phone, and Internet, and separates these communications for the appropriate devices. The data/communications may be received via access network 120 and/or via satellite receiver 139, for instance. In one example, television data is forwarded to set-top boxes (STBs)/digital video recorders (DVRs) 162A and 162B to be decoded, recorded, and/or forwarded to television (TV) 163 and/or immersive display 168 for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A and 167B, IoTs 170 and so forth.

In one example, router 165 may further communicate with TV (broadly a display) 163 and/or immersive display 168, e.g., where one or both of the television and the immersive display incorporates “smart” features. The immersive display may comprise a display with a wide field of view (e.g., in one example, at least ninety to one hundred degrees). For instance, head mounted displays, simulators, visualization systems, cave automatic virtual environment (CAVE) systems, stereoscopic three dimensional displays, and the like are all examples of immersive displays that may be used in conjunction with examples of the present disclosure. In other examples, an “immersive display” may also be realized as an augmentation of existing vision augmenting devices, such as glasses, monocles, contact lenses, or devices that deliver visual content directly to a user's retina (e.g., via mini-lasers or optically diffracted light). In further examples, an “immersive display” may include visual patterns projected on surfaces such as windows, doors, floors, or ceilings made of transparent materials.

In another example, the router 165 may further communicate with one or more IoTs 170, e.g., a connected security system, an automated assistant device or interface, a connected thermostat, a connected speaker system, or the like. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections.

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided. For example, one or both of the STB/DVR 162A and STB/DVR 162B may host an operating system for presenting a user interface via TVs 163 and/or immersive display 168, respectively. In one example, the user interface may be controlled by a user via a remote control or other control devices which are capable of providing input signals to a STB/DVR. For example, mobile device 167A and/or mobile device 167B may be equipped with an application to send control signals to STB/DVR 162A and/or STB/DVR 162B via an infrared transmitter or transceiver, a transceiver for IEEE 802.11 based communications (e.g., “Wi-Fi”), IEEE 802.15 based communications (e.g., “Bluetooth”, “ZigBee”, etc.), and so forth, where STB/DVR 162A and/or STB/DVR 162B are similarly equipped to receive such a signal. Although STB/DVR 162A and STB/DVR 162B are illustrated and described as integrated devices with both STB and DVR functions, in other, further, and different examples, STB/DVR 162A and/or STB/DVR 162B may comprise separate STB and DVR components.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

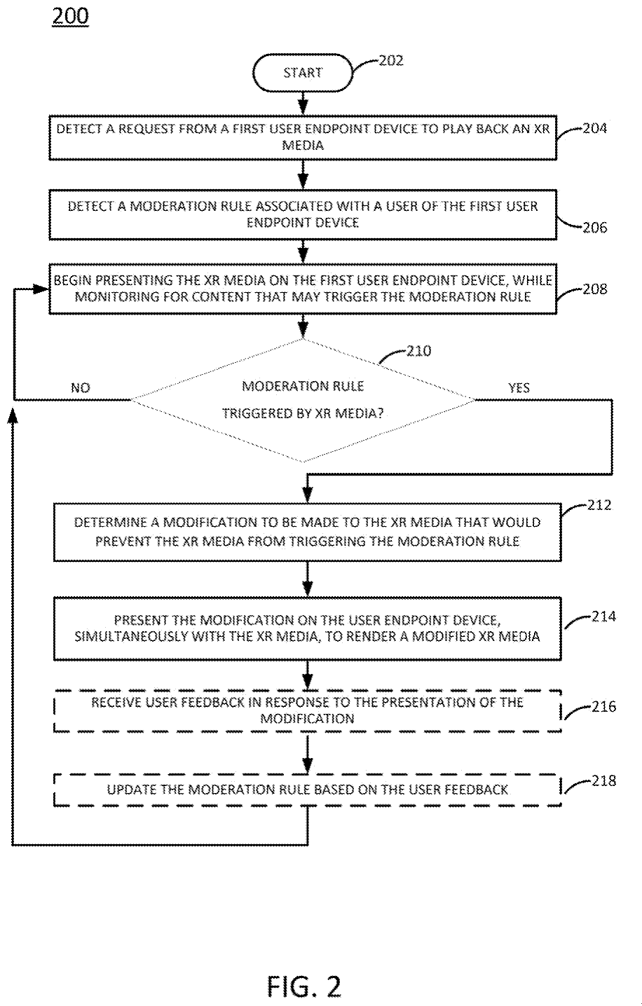

FIG. 2 illustrates a flowchart of an example method 200 for providing content moderation for extended reality media, in accordance with the present disclosure. In one example, steps, functions and/or operations of the method 200 may be performed by a device as illustrated in FIG. 1, e.g., immersion server 115 or any one or more components thereof. In one example, the steps, functions, or operations of method 200 may be performed by a computing device or system 300, and/or a processing system 302 as described in connection with FIG. 3 below. For instance, the computing device 300 may represent at least a portion of the immersion server 115 in accordance with the present disclosure. For illustrative purposes, the method 200 is described in greater detail below in connection with an example performed by a processing system, such as processing system 302.

The method 200 begins in step 202. In step 204, the processing system may detect a request from a first user endpoint device to play back an XR media. The first user endpoint device may be any type of device that is capable of presenting an immersive experience, either alone or in combination with other devices. For instance, the first user endpoint device may comprise an immersive display, such as a head mounted display, a stereoscopic three-dimensional display, or the like. The first user endpoint device may also comprise a more conventional display, such as a television, a tablet computer, or the like, that is co-located (e.g., in the same room as) with one or more IoT devices, such as a smart thermostat, a smart lighting system, a smart audio system, a virtual assistant device, or the like. In such cases, the immersive experience may comprise a visual component. For instance, in one example, the XR media may be an immersive film or television show, a video game, a virtual tour, a training simulation, or the like.

In step 206, the processing system may detect a moderation rule associated with a user of the first user endpoint device. In one example, the moderation rule may be obtained from a profile associated with a user of the first user endpoint device.

In one example, the user of the first user endpoint device may log into an account to play the XR media, and the account may further be associated with a plurality of profiles for different users of the account. For instance, different members of the same family may have different profiles under the same family account with a streaming video service or an online gaming service. A profile for a given user may identify an age or age range of the user, content ratings that the user is permitted to consume (e.g., all ratings, up to PG or Y7, etc.), and any additional moderation rules that apply for the user. In one example, moderation rules may be selected via a drop down menu, radio button, or other interfaces that present a predefined list of available moderation rules and allow a user to select any number of the available moderation rules.

In a related example, different moderation rules may be applied based on how the user received the content. For example, if the content was discovered via a broadcast message from an employer, a video or Internet search engine, a friend on a social network, or a family member, the moderation rules applied to the content may decrease in rule count (e.g., the number of restrictions or explicit conditions that are applicable) and magnitude (e.g., the intensity of the moderation impact on language, humor, or violence in the content). In another example, the rule count and magnitude of the applied moderation rules may be automatically modified based on the accumulated views (e.g., from a crowd-sourced video platform) or implied trust (e.g., ratings or number of personal contacts of a user who have viewed the content) which are aggregated for content from third-party sources.

For instance, available moderation rules may allow a user to filter out content that includes cigarettes, drugs, guns, strong language, nudity, fighting, blood, and the like. In another example, the selection of a generic profile by a user (e.g., “child,” “no violence,” etc.) may be associated with a set of preselected moderation rules based on the experiences of previously opted in, laboratory-based users. In another example, a user may be able to specify a moderation rule that is not predefined. Thus, parents may set up moderation rules that limit the types of content that can be presented to their children, or an adult user may set up moderation rules to filter out content that the adult user finds uncomfortable or objectionable. In such a case, the processing system may identify the profile that is currently logged in on the first user endpoint device, and may identify what moderation rules (if any) are associated with the profile.

In another example, moderation rules may be used not to identify content that may be objectionable, but to identify content that provides an opportunity for customization (for instance, for advertising purposes). As an example, a moderation rule may be used to detect when corporate logos appear in the XR content.

In one example, the processing system may be part of a device (e.g., an application server) that provides a moderation service that is independent of any particular media content service provider. For instance, the user may subscribe to a service that performs moderation of content that is provided by other services. In this case, the profile associated with the user may be identified when the user logs into an account with the service, or when the service identifies the first user endpoint device that is making the request for the playback of the XR media (e.g., by IP address, media access control address, or some other identifiers).

In another example, if the moderation rule is not specified in a user profile, then the request may specify the moderation rule. For instance, the user may request moderation of certain content on a case-by-case basis (e.g., the user may not mind violence in general, but may not enjoy a type of over the top violence that is frequently employed by a particular director). Thus, when the processing system receives the request to play back the XR media, the request may include the moderation rule to be applied to the XR media. In one example, where content creators or distributors know in advance what types of content may be objectionable to some viewers in an XR media, a particular XR media may include content warnings along with options to filter any one of the types of content for which the warnings are provided. In this case, the user may select one or more of the options when selecting the XR media for playback. In another example, the user may request a moderation rule that is not associated with a predefined content warning.

In step 208, the processing system may begin presenting the XR media on the first user endpoint device, while monitoring for content that may trigger the moderation rule. As discussed above, presenting the XR media may comprise delivering a computer-generated overlay to the first user endpoint device, so that the first user endpoint device may display the computer-generated overlay in conjunction with a separate item of media content (e.g., a live or prerecorded media stream). In another example, presenting the XR media may comprise delivering a computer-generated item of media content that comprises the XR media in its totality (e.g., the media delivered to the first user endpoint device does not need to be presented in conjunction with another item of media content to produce an immersive experience). In another example, presenting the XR media may comprise sending commands to one or more other devices that are co-located with the first user endpoint device (e.g., IoT devices such as smart thermostats, smart lighting systems, smart audio systems, virtual assistant devices, and the like), where the commands instruct the one or more other devices to adjust their settings while an item of media content is playing on the first user endpoint device.

In one example, the XR media has been processed, prior to the presenting, to identify segments (e.g., scenes, chapters, video game levels, or the like) that may include events which may trigger a moderation rule. For example, events depicting common sources of content warnings (e.g., violence, strong language, or adult situations) may be identified in metadata for the XR media, so that the processing system can detect when segments containing this type of content are coming up. The metadata may also identify the events with greater specificity to aid in moderation for more specific types of content. For instance, rather than identifying “violence” in general, the metadata may identify “guns” or “blood.” The metadata may also identify depictions of cigarettes, drugs, alcohol, loud noises (e.g., explosions, loud vehicles, gunfire, etc.), rude gestures, and/or other types of content that a user may find objectionable under different circumstances.

In another example, the XR media may not have been processed prior to the presenting to identify segments containing events with may trigger a moderation rule. For instance, the XR media may comprise a live broadcast or a prerecorded media that has not been annotated with metadata (but which may still include general content warnings without reference to the specific portions of the XR media that contain the content alluded to in the warnings). In this case, the processing system may analyze the XR media during the presentation of the XR media (e.g., in real time during playback). In one example, the processing system may analyze the XR media a few frames or seconds ahead of the segment of the XR media that is currently being presented, so that content which may trigger a moderation rule can be detected before the content is presented.

For instance, in one example, the processing system may utilize image processing techniques, such as facial recognition, object recognition, or the like, in order to detect when characters, actors, personalities, or objects that may trigger a moderation rule appear in the visual component of the XR media. In one example, the analysis may be guided or narrowed down by the moderation rule that was identified in step 206. For instance, if the moderation rule indicates that references to cigarettes should be filtered out of the XR media, then the processing system may use object recognition techniques to detect when a cigarette is depicted in the visual component of the XR media. Similarly, if the moderation rule indicates that a particular character should be filtered out of the XR media, then the processing system may use facial recognition techniques to detect when the character is present in the visual component of the XR media.

In another example, the processing system may utilize audio processing techniques, such as speech recognition, sentiment analysis, or the like, in order to detect when dialogue, narration, music, or voiceovers that may trigger a moderation rule occur in the audible component of the XR media. For instance, if the moderation rule indicates that swearing should be filtered out of the XR media, then the processing system may use speech recognition to detect when a keyword associated with swearing occurs in the audible component of the XR media.

In step 210, the processing system may determine whether the moderation rule has been triggered by the XR media. For instance, as discussed above, analysis of either metadata associated with the XR media or the content of the XR media may help the processing system to identify when the content of the XR media triggers a moderation rule. If the processing system determines in step 210 that the moderation rule has not been triggered by the XR media, then the method 200 may return to step 208 and continue to monitor for content that may trigger the moderation rule while presenting the XR media.

If, however, the processing system determines in step 210 that the moderation rule has been triggered by the XR media, then the method 200 may proceed to step 212. In step 212, the processing system may determine a modification to be made to the XR media that would prevent the XR media from triggering the moderation rule. In one example, the modification may be specified by the moderation rule itself. For instance, if the moderation rule indicates that that cigarettes should not be depicted in the visual component of the XR media, the moderation rule may also indicate that when a cigarette appears in the XR media, the cigarette should be erased or should be replaced with a lollipop. Similarly, the moderation rule may indicate that when a specific fast food logo is detected, the specific fast food logo should be removed or should be replaced with a different fast food logo. Another moderation rule may indicate that when a specific keyword is detected in the audio component of the XR media, that the specific keyword should be replaced with a different word. In one example, where the moderation rule specifies the modification to be made to the XR content, the specified modification may also be pre-recorded or pre-rendered. For instance, the specified modification could be provided by the content creator.

In another example, where the moderation rule does not specify how to modify the XR media, the processing system may autonomously determine how to modify the XR media to avoid triggering the moderation rule. For instance, if the processing system has used object recognition techniques to detect an object in the visual component of the XR media that triggers the moderation rule, then the processing system may also know the location and approximate size and dimensions of the object. Thus, the processing system may be able to render an overlay that can be applied to one or more frames of the visual component to either remove the object or replace the object with a different object (e.g., positioned in the same location as the removed object and having approximately the same size and dimensions). Similarly, if the processing system has used speech recognition processing to detect a keyword in the audio component of the XR media that triggers a moderation rule, the processing system could render a synthesized (or pre-recorded) audio track that replaces the keyword with a different word. The different word may be selected using phonological processing or understanding. For instance, the different word may be selected to be a word that shares phonemes with the keyword (e.g., starts or ends with the same sound) or that contains the same number of syllables. The different word could also be selected using sentiment understanding, e.g., such that the different word may have a similar meaning to the keyword but may express the meaning in a less offensive manner.

In a similar example, where a spoken word is to be moderated, the processing system may generate both audio for an alternate word by phoneme matching, direct vocabulary matching, and/or the like, and may also modify the visual representation of the speaker (e.g., modify the speaker's lip movements in the video) to match the replaced word. If the visual representation is a static or flat two-dimensional image, a generative adversarial network (GAN) or other machine learning techniques may be applied to seamlessly replace the original spoken word in the content. If the visual representation is a three-dimensional avatar, the processing system may alter the kinematics used to actuate the avatar's mouth movements, either using previously determined rules from the content author or generating new rules based on similar avatar anatomy interactions.

In step 214, the processing system may present the modification on the user endpoint device, simultaneously with the XR media, to render a modified XR media. For instance, if the modification is a modification to the visual component of the XR media that is implemented as a digital overlay, then the processing system may deliver the overlay to the user endpoint device along with instructions for synchronizing the overlay with the visual component of the XR media so that the modification appears to be seamless. If the modification is a modification to the audio component of the XR media that is implemented as a short-duration replacement audio track, then the processing system may deliver the replacement track along with instructions for synchronizing the replacement track with audio component (e.g., when to mute the audio component and play the replacement track).

In optional step 216 (illustrated in phantom), the processing system may receive user feedback in response to the presentation of the modification. In one example, the user feedback may comprise explicit feedback indicating whether or not the first presentation of the modification was effective in seamlessly moderating the XR media for the content for which the moderation rule was implemented. For instance, the user of the user endpoint device may provide a signal via an interactive dialog to indicate whether or not the user was satisfied with the modification (e.g., whether the modification adequately removed the objectionable content, whether any objectionable content was missed by the modification, whether or not the modification was conspicuous, etc.).

Alternatively, the user feedback may comprise implicit feedback. For instance, if the user paused, fast forwarded, or ended the presentation of the XR media after the modification was presented, this may be inferred as a sign that the user was dissatisfied with the presentation of the modification.

In optional step 218 (illustrated in phantom), the processing system may update the moderation rule based on the user feedback. For instance, in one example, the moderation rule may be updated to indicate the content that was modified, the nature of the modification (e.g., remove, replace, etc.), and/or whether the user was satisfied with the modification. For instance, if the user indicates that a replacement word that was used to replace a keyword in the audio component of the XR media sounded awkward, then the moderation rule may be updated to note that the replacement word should not be used to replace the keyword in the future (at least for the user of the user endpoint device).

The method 200 may then return to step 208, and the processing system may proceed as described above to monitor for content that may trigger the moderation rule while presenting the XR media. Thus, steps 208-218 may be repeated any number of times until presentation of the XR media concludes (e.g., the XR media may come to a scheduled end, or the user may pause or exit the XR media before a scheduled end).

The method 200 therefore allows XR media to be filtered in different ways for different users, based in the different preferences of the different users for whom the XR media is being rendered; thus, different versions of the XR media may be rendered for different users. For instance, a first user could request that cigarettes or drugs be filtered out of the XR media, while a second user could request that guns be filtered out. In further examples still, rather than the user, it may be the distribution platform for the XR media that imposes the content moderation (e.g., an immersive film being broadcast on a channel that provides family friendly programming may filter the content to remove swearing).

Further examples of the present disclosure could also be applied to enhance advertising opportunities in XR media. For instance, the method 200 could be used to detect when a corporate logo appears in the XR media and to replace the corporate logo with a different corporate logo (or with nothing). As an example, the XR media may depict an image of a paper bag, where the paper bag displays the logo of a well-known fast food chain. The logo could be detected and replaced with a logo of a different fast food chain.

Similar changes could be made for different demographics of users. For instance, if a character in the XR media is depicted wearing a hat with the logo of a Boston baseball team, the logo could be replaced with a logo of a New York baseball team when the XR media is presented in New York markets. The demographics information may include traditional user-specific details (e.g., age, gender, etc.) and may also include behavioral or environmental details that are provided by the user's context (e.g., current location, a summary of interactions with the XR media in the last x minutes, device-specific details about where the XR media is being consumed, etc.).

Still further examples of the present disclosure could extrapolate modifications made for one user or for a small group of users sharing some demographic to the larger demographic. For instance, if it is determined that multiple users have requested moderation of content depicting cigarettes when the XR media is presented to children, then the moderation of the content depicting cigarettes could be implemented in a general set of “kid friendly” moderation settings (e.g., where rather than individually selecting moderation rules for different content types, a user may simply select the kid friendly moderation settings, and the processing system will automatically moderate for a plurality of content types associated with the kid friendly settings).

Still further examples of the present disclosure could assist with fields that are not strictly entertainment related. For instance, an XR media may simulate a real world environment or experience that can be used for therapeutic purposes (e.g., to address phobias or prepare for new life experiences). Content like strobing lights could be moderated for presentation to users with sensory sensitivities or medical conditions that could be triggered by the lights. In another example, the processing system could be engaged in an educational format to help a user adjust to a new working condition.

It should be noted that the method 200 may be expanded to include additional steps or may be modified to include additional operations with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for providing content moderation for extended reality media, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 305 for providing content moderation for extended reality media (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for providing content moderation for extended reality media (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
detecting, by a processing system including at least one processor, a request from a first user endpoint device to play back an extended reality media;
detecting, by the processing system, a moderation rule associated with a user of the first user endpoint device;
presenting, by the processing system, the extended reality media on the first user endpoint device, while monitoring for content within the extended reality media that triggers the moderation rule;
determining, by the processing system in response to detecting content in the extended reality media that triggers the moderation rule, a modification to be made to the extended reality media that would prevent the extended reality media from triggering the moderation rule; and
presenting, by the processing system, the modification on the user endpoint device, simultaneously with the extended reality media, to render a modified extended reality media.

2. The method of claim 1, wherein the moderation rule identifies a type of content to be filtered from the extended reality media.

3. The method of claim 2, wherein the type of content is an object that appears in a visual component of the extended reality media.

4. The method of claim 3, wherein the modification comprises a computer generated visual overlay.

5. The method of claim 3, wherein the detecting the content in the extended reality media that triggers the moderation rule comprises detecting metadata associated with the visual component that indicates an appearance of the object.

6. The method of claim 3, wherein the detecting the content in the extended reality media that triggers the moderation rule comprises:
performing, by the processing system, an image analysis technique on the visual component to recognize the object in the visual component.

7. The method of claim 2, wherein the type of content is a word that is detected in an audio component of the extended reality media.

8. The method of claim 7, wherein the modification comprises an alternate audio track to replace a portion of the audio component.

9. The method of claim 7, wherein the detecting the content in the extended reality media that triggers the moderation rule comprises:
performing, by the processing system, an audio analysis technique to recognize a plurality of words in the audio component, wherein the word that is detected is one of the plurality of words; and
matching the word that is detected to a keyword, where the user has requested that the keyword be filtered out of the extended reality media.

10. The method of claim 1, wherein the moderation rule defines the modification.

11. The method of claim 10, wherein the modification comprises a prerecorded modification.

12. The method of claim 1, wherein the processing system generates the modification without using a prerecorded modification.

13. The method of claim 1, further comprising:
receiving, by the processing system, feedback from the user in response to the presenting the modification; and
updating, by the processing system, the moderation rule based on the feedback.

14. The method of claim 1, wherein the moderation rule is defined by the user.

15. The method of claim 1, wherein the moderation rule is defined by a creator or a broadcaster of the extended reality media.

16. The method of claim 1, wherein the content in the extended reality media that triggers the moderation rule comprises a first corporate logo, and the modification comprises a second corporate logo that replaces the first corporate logo.

17. The method of claim 1, wherein the modification is made for a regional audience including the user.

18. The method of claim 1, wherein the modification is made for a location of the user and a proximal collection of users.

19. A non-transitory computer-readable medium storing instructions which, when executed by a processing system including at least one processor, cause the processing system to perform operations, the operations comprising:
detecting a request from a first user endpoint device to play back an extended reality media;
detecting a moderation rule associated with a user of the first user endpoint device;
presenting the extended reality media on the first user endpoint device, while monitoring for content within the extended reality media that triggers the moderation rule;
determining, in response to detecting content in the extended reality media that triggers the moderation rule, a modification to be made to the extended reality media that would prevent the extended reality media from triggering the moderation rule; and
presenting the modification on the user endpoint device, simultaneously with the extended reality media, to render a modified extended reality media.

20. A device comprising:
a processor; and
a computer-readable medium storing instructions which, when executed by the processor, cause the processor to perform operations, the operations comprising:
detecting a request from a first user endpoint device to play back an extended reality media;
detecting a moderation rule associated with a user of the first user endpoint device;
presenting the extended reality media on the first user endpoint device, while monitoring for content within the extended reality media that triggers the moderation rule;
determining, in response to detecting content in the extended reality media that triggers the moderation rule, a modification to be made to the extended reality media that would prevent the extended reality media from triggering the moderation rule; and
presenting the modification on the user endpoint device, simultaneously with the extended reality media, to render a modified extended reality media.
